(19) United States
(12) Patent Application Publication
(10) Pub. No.: US 2024/0078280 A1
(43) Pub. Date: Mar. 7, 2024

(54) WEB BROWSING SYSTEM, COMMUNICATION TERMINAL, AND CONTROL METHOD THEREOF

(71) Applicant: CANON KABUSHIKI KAISHA, Tokyo (JP)

(72) Inventor: ATSUSHI IKEDA, Ibaraki (JP)

(21) Appl. No.: 18/459,714

(22) Filed: Sep. 1, 2023

(30) Foreign Application Priority Data
Sep. 6, 2022 (JP) 2022-141123

(51) Int. Cl. G06F 16/957; G06F 21/33; H04L 67/306

(52) U.S. Cl. CPC G06F 16/9577; G06F 21/33; H04L 67/306

(57) ABSTRACT

In a cloud browser system, an image forming apparatus stores user data previously acquired from an image generation server and transmits a uniform resource locator (URL) of a Web page and the stored user data to the image generation server. The image generation server receives the URL and the user data, accesses the Web page based on the URL and the user data, and generates a rendering image by interpreting the Web page. The image forming apparatus receives the rendering image corresponding to a result acquired by accessing the Web page by using the user data from the image generation server.

### BACKGROUND

### Field of the Disclosure

The present disclosure relates to a Web browsing system in which a browser engine is offloaded on a cloud. Examples of a communication terminal capable of using the above-described Web browsing system include image processing apparatuses, such as a printer, a scanner, a facsimile (FAX), and a multifunction peripheral having the functions of the printer, the scanner, and the FAX, and general-purpose information processing apparatuses, such as a personal computer and a mobile terminal.

### Description of the Related Art

Communication terminals, such as an image processing apparatus (information processing apparatus) including a Web browser (hereinafter, referred to “browser”), which has a function of browsing a Web page on the browser, have been known. A communication terminal that has accessed a Web page of an external service through the Web browser can expand the functions by cooperating with the external service.

Nowadays, a system called a “cloud browser”, which uses an image generation server for generating a rendering result of a Web page on a cloud server is considered. Japanese Patent Application Laid-Open No. 2022-41717 discusses a system which renders a Web page using a virtual machine existing in a network different from a communication terminal and displays the rendering result on the communication terminal. Japanese Patent Application Laid-Open No. 2022-41717 also discusses a technique for saving a file that is generated while a Web page is interpreted and processed by a browser engine of one virtual machine, in an optional place on the cloud, and sharing the file with a browser engine on another virtual machine.

### SUMMARY

According to an aspect of the present disclosure, a Web browsing system includes a server configured to perform rendering of a Web page and a communication terminal configured to display the Web page based on a result of the rendering. The communication terminal includes a unit configured to store user data previously acquired from the server, the user data having been acquired through interpretation of the Web page, a unit configured to transmit address information of the Web page and the user data stored, and a unit configured to receive a rendering image from the server, the rendering image corresponding to a result from accessing the Web page by using the user data. The server includes a unit configured to receive the address information and the user data from the communication terminal, and a unit configured to access the Web page based on the address information and the user data, generate the rendering image by interpreting the Web page, and transmit the rendering image to the communication terminal.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an entire cloud browser system.

FIG. 2A is a block diagram illustrating an example of a hardware configuration of a virtual machine operating in the cloud browser system. FIG. 2B is a block diagram illustrating an example of a software configuration of the virtual machine operating in the cloud browser system.

FIG. 3A is a block diagram illustrating a hardware configuration of an image forming apparatus operating in the cloud browser system. FIG. 3B is a block diagram illustrating a software configuration of the image forming apparatus operating in the cloud browser system.

FIG. 4 is a diagram illustrating an example of a home screen displayed on an operation unit of the image forming apparatus.

FIG. 5 is a diagram illustrating an example of a browser screen.

FIGS. 6A and 6B illustrate a sequence diagram of standard processing executed by respective blocks included in the cloud browser system.

FIG. 7 is a flowchart illustrating a flow of user data saving area determination processing executed by a browser control unit.

FIG. 8 is a flowchart illustrating a flow of user data synchronization processing executed by the browser control unit and a browser processing unit.

FIG. 9 is a flowchart illustrating a flow of user data back-up processing executed by the browser control unit and the browser processing unit.

FIG. 10 is a sequence diagram illustrating standard processing executed by the respective blocks included in the cloud browser system according to one or more aspects of the present disclosure.

FIGS. 11A and 11B are diagrams illustrating examples of a bToken issued by the browser processing unit.

FIG. 12 is a diagram illustrating an example of a structure of a folder where user data is saved.

FIG. 13 is a diagram illustrating an example of a structure of user data.

### DESCRIPTION OF THE EMBODIMENTS

Hereinafter, exemplary embodiments embodying the present disclosure will be specifically described with reference to the drawings. The scope of the present disclosure is not limited to the configuration described in the exemplary embodiments. Changes and/or modifications, e.g., replacement of a part of configurations or processing with equivalents and/or omission of a part of configurations or processing, may be made within a range where similar effect is acquired.

### <Cloud Browser System>

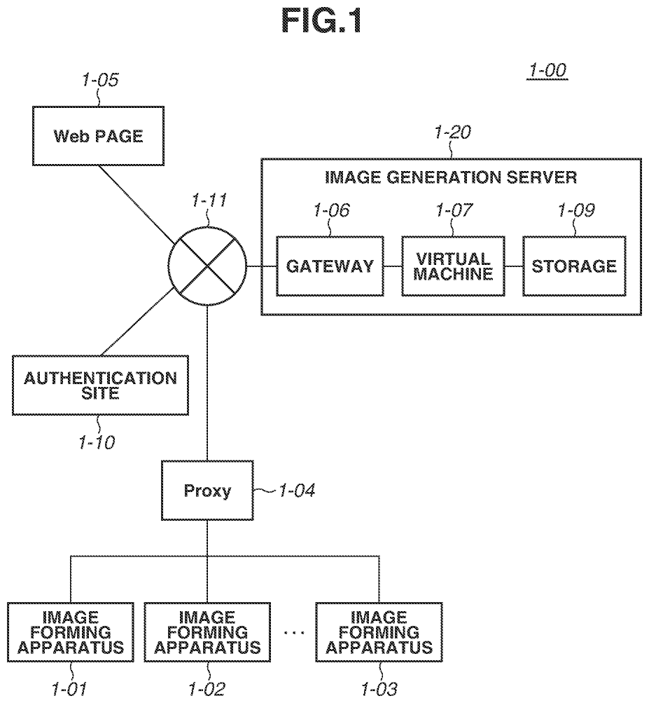

FIG. 1 is a diagram illustrating an overall configuration of a cloud browser system. A cloud browser system 1-00 is a Web browsing system which executes rendering of Web content on the cloud. The cloud browser system 1-00 includes a plurality of image forming apparatuses 1-01 to 1-03 and an image generation server 1-20 to which these image forming apparatuses 1-01 to 1-03 are connected.

The cloud browser system 1-00 further includes a Web page 1-05 (i.e., Web content providing server) which provides a Web page, a Proxy 1-04, and an authentication site 1-10, or the cloud browser system 1-00 cooperates therewith as external services. In the example illustrated in FIG. 1, the three image forming apparatuses 1-01 to 1-03 are connected to the single image generation server 1-20. However, any number of image forming apparatuses can be connected to the image generation server 1-20. Further, the image generation server 1-20 provides service to the plurality of image forming apparatuses 1-01 to 1-03 in parallel or in time division. The number of image generation server 1-20 included in the cloud browser system 1-00 is relatively small compared to the number of image forming apparatuses. For the purpose of sharing the load, a plurality of image generation servers may be arranged in the cloud browser system 1-00. Hereinafter, a relationship with the image generation server 1-20 is described by taking the image forming apparatus 1-01 as a representative example of the plurality of image forming apparatuses.

The image generation server 1-20 is a system which acts as a substitute to provide a rendering service of Web content in the cloud. The image generation server 1-20 includes a gateway 1-06, a virtual machine 1-07, and a storage 1-09. A browser engine provided as a software module operates on the virtual machine 1-07 of the image generation server 1-20, although details thereof are described below. The browser engine receives a uniform resource locator (URL) of the Web page 1-05 transmitted from the image forming apparatus 1-01 via the gateway 1-06. The browser engine then accesses the Web page 1-05 corresponding to the received URL via the gateway 1-06, and receives Web content, such as hypertext markup language (HTML), from the Web page 1-05.

Thereafter, a rendering result of the received Web content is generated by another software module for executing rendering. The rendering result is transmitted to the image forming apparatus 1-01 via the gateway 1-06.

For the sake of simplicity, in a first exemplary embodiment, only one virtual machine 1-07 is included in the image generation server 1-20. However, for example, a plurality of virtual machines 1-07 can be included in the image generation server 1-20 in order to improve the availability and durability. In this case, a load balancer is arranged between the gateway 1-06 and the virtual machines 1-07. The storage 1-09 can be shared by the plurality of virtual machines 1-07, while a browser engine is operated in one virtual machine 1-07 selected therefrom depending on a load state.

The storage 1-09 included in the image generation server 1-20 stores non-volatile information, such as setting information used to operate the browser engine. Alternatively, the storage 1-09 can be used as a user data cache area as described below. Alternatively, as described below, the storage 1-09 can be used as a rendering result storage area.

The image forming apparatus 1-01 is an image processing apparatus (an information processing apparatus or a communication terminal) having a function of forming (printing) an image on a sheet (a sheet of paper) or a function of transmitting image data generated by scanning an image to an optional destination. The image forming apparatus 1-01 can be a printer operating as a multifunction peripheral (MFP) or a single-function peripheral (SFP). Alternatively, a printing method of the image forming apparatus 1-01 can be either an electrophotographic method or an ink jet method. The image forming apparatus 1-01 according to the present exemplary embodiment uses the image generation server 1-20 to browse and display the Web content on the internet. Details thereof will be described below.

The Proxy 1-04 is a server which monitors and limits the communication executed between the network where the image forming apparatus 1-01 belongs to and the Internet. The Proxy 1-04 executes URL filtering (Web filtering) to limit access to the Web site.

### <Virtual Machine>

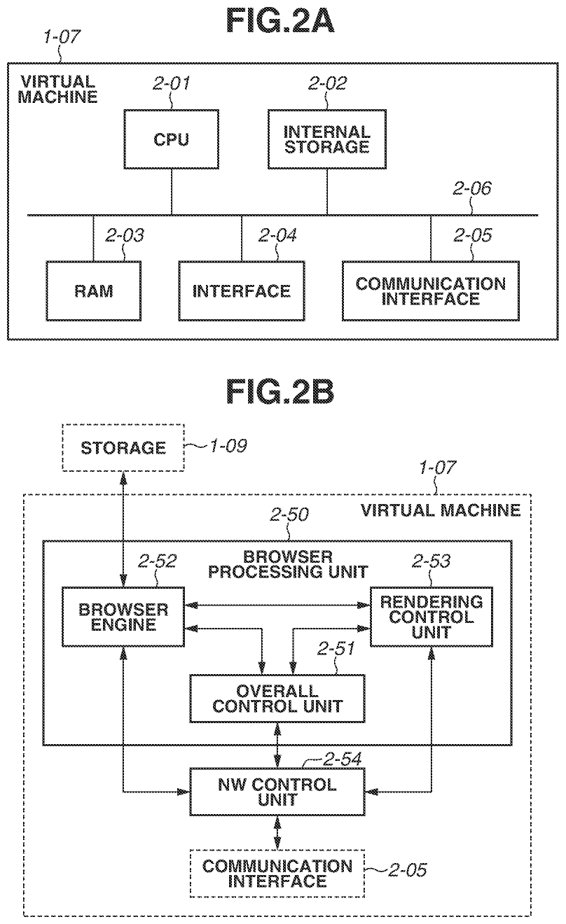

FIG. 2A is a block diagram illustrating an example of a hardware configuration of the virtual machine 1-07 operating in the cloud browser system 1-00.

The virtual machine 1-07 includes a central processing unit (CPU) 2-01, an internal storage 2-02, a random access memory (RAM) 2-03, an interface 2-04, and a communication interface 2-05. These constituent elements are communicably connected to each other via a bus 2-06.

The CPU 2-01 is a control unit for executing various types of control of the virtual machine 1-07. The CPU 2-01 executes various types of processing by using a computer program and data stored in the internal storage 2-02. Through the processing, the CPU 2-01 controls the entire operation of the virtual machine 1-07, and executes or controls the processing operated on the virtual machine 1-07 described below.

The internal storage 2-02 stores setting data of the virtual machine 1-07, a computer program and data relating to activation of the virtual machine 1-07, and a computer program and data relating to the basic operation of the virtual machine 1-07.

The RAM 2-03 includes an area where a computer program and data loaded from the internal storage 2-02 and data received from an external apparatus via the communication interface 2-05 are stored. The RAM 2-03 also includes a work area used when the CPU 2-01 executes various types of processing. As described above, the RAM 2-03 can appropriately provide various areas (storage areas). In the present exemplary embodiment, a part of the area in the RAM 2-03 is used as a cache area for user data described below.

The interface 2-04 includes a display unit for displaying a result of the processing executed by the CPU 2-01 with images or characters, and an operation unit for allowing the user to perform various types of operation input. The display unit includes a liquid crystal screen and a touch panel screen. The operation unit includes user interfaces, such as a keyboard, a mouse, and a touch panel screen.

The communication interface 2-05 is an interface for executing data communication with an external apparatus. For example, a network interface compatible with the Ethernet® is used as the communication interface 2-05.

The configuration illustrated in FIG. 2A is merely an example of the configuration applicable to the virtual machine 1-07, and is not intended to be limited to the configuration illustrated in FIG. 2A. For example, in the configuration illustrated in FIG. 2A, a memory device can additionally be connected to the bus 2-06. Examples of the memory device include a hard disk drive, a universal serial bus (USB) memory, a magnetic card, an optical card, an integrated circuit (IC) card, a memory card, and a drive device.

The virtual machine 1-07 can be provided by a so-called virtual technique, and various resources that constitute a computer system can be organized into a logical unit independent from physical constitution. In other words, the virtual machine 1-07 can be provided by using a plurality of resources integrated with each other, or can be provided by using a divided part of one resource. It is also possible to provide the virtual machine 1-07 by using at least a part of the resources of the information processing system included in the cloud. The resources can include a plurality of apparatuses.

FIG. 2B is a block diagram illustrating a software configuration of the virtual machine 1-07 operating in the cloud browser system 1-00. As illustrated in FIG. 2B, the virtual machine 1-07 includes a browser processing unit 2-50 and a network (NW) control unit 2-54 as software modules.

The browser processing unit 2-50 is a module which is in charge of general processing relating to a browser executed in the cloud. The browser processing unit 2-50 is a major part of the cloud browser system 1-00. The browser processing unit 2-50 includes an overall control unit 2-51, a browser engine 2-52, and a rendering control unit 2-53.

The overall control unit 2-51 is a module which controls the entirety of the browser processing unit 2-50 operating on the virtual machine 1-07. When the user operates the image forming apparatus 1-01 to input a browsing request of a desired Web page 1-05, a URL of the Web page 1-05 is transmitted to the image generation server 1-20 from the image forming apparatus 1-01 via the Proxy 1-04. The overall control unit 2-51 functions to collectively accept various requests transmitted from the image forming apparatus 1-01. The overall control unit 2-51 also functions to distribute the accepted requests to the below-described browser engine 2-52 or the rendering control unit 2-53 as appropriate.

Based on the URL transmitted from the overall control unit 2-51, the browser engine 2-52 accesses the Web page 1-05 illustrated in FIG. 1 via the below-described NW control unit 2-54 to acquire the Web content. The browser engine 2-52 includes a function of a Hyper Text Transfer Protocol (HTTP) client to be used for acquiring the Web content. The browser engine 2-52 analyzes the acquired Web content and appropriately saves the information, such as cookies, in a specific area of the RAM 2-03 illustrated in FIG. 2A. The browser engine 2-52 also functions to refer to the information, such as the cookies, previously saved in the specific area of the RAM 2-03. Furthermore, the browser engine 2-52 requests the below-described rendering control unit 2-53 to execute rendering processing when analysis of the Web content is completed.

The rendering control unit 2-53 functions to render the Web content based on the rendering request received from the browser engine 2-52. The rendering control unit 2-53 also functions to return the rendering result to the image forming apparatus 1-01 serving as a request source of the URL via the NW control unit 2-54 described below. At this time, the storage 1-09 can be used as an area where the rendering result is stored, and the rendering control unit 2-53 forwards the image data stored in the storage 1-09.

The NW control unit 2-54 is a module which receives requests for accessing outside from the overall control unit 2-51, the browser engine 2-52, and the rendering control unit 2-53, and mediates communication executed thereby. The outside to which the access requests are to be transmitted can be the image forming apparatus 1-01, the Web page 1-05, or the authentication site 1-10. The NW control unit 2-54 further includes a protocol stack of HTTP communication used to access the Web page 1-05. When the NW control unit 2-54 actually executes communication, the NW control unit 2-54 controls the communication interface 2-05 illustrated in FIG. 2A to execute communication with the image forming apparatus 1-01, the Web page 1-05, and the authentication site 1-10.

### <Image Forming Apparatus>

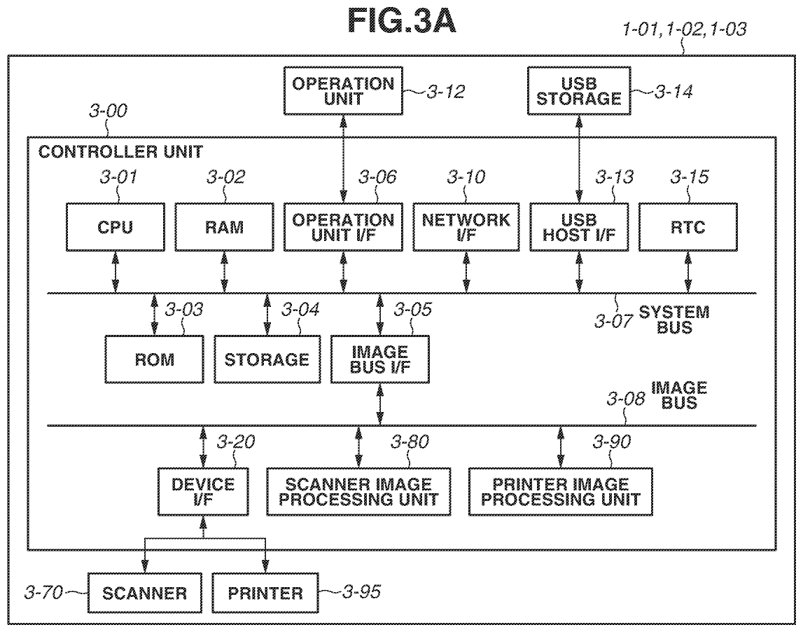

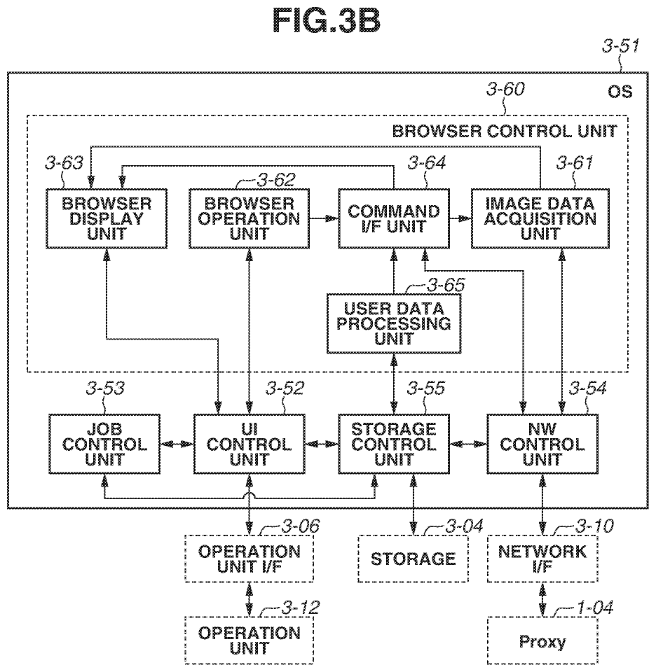

FIG. 3A is a block diagram illustrating a hardware configuration of the image forming apparatus 1-01 operating in the cloud browser system 1-00. The image forming apparatus 1-01 includes a controller unit 3-00, an operation unit 3-12, a USB storage 3-14, a scanner 3-70, and a printer 3-95.

The scanner 3-70 serving as an image input device, the printer 3-95 serving as an image output device, and the operation unit 3-12 are connected to the controller unit 3-00.

The operation unit 3-12 displays information to the user and receives an input from the user.

The operation unit 3-12 includes, for example, a display, a touch panel sensor, and a hardware key.

The USB storage 3-14 is an external storage device which stores data. The USB storage 3-14 can be attached to and detached from a USB host interface (I/F) 3-13.

The scanner 3-70 is an image reading unit (an image reading device or an image input device) which reads an image from a document.

The printer 3-95 is an image forming unit (an image forming device or an image output device) which forms an image on a sheet (a sheet of paper).

The controller unit 3-00 is a control unit which includes a constituent element for executing various types of control processing in the image forming apparatus 1-01. The controller unit 3-00 executes control processing for executing, for example, a copy function for printing and outputting image data read by the scanner 3-70 from the printer 3-95.

The controller unit 3-00 includes a CPU 3-01, a RAM 3-02, a ROM 3-03, a storage 3-04, and an image bus I/F 3-05. These constituent elements are communicably connected to each other via a system bus 3-07.

The controller unit 3-00 further includes an operation unit I/F 3-06, a network I/F 3-10, a USB host I/F 3-13, a real-time clock (RTC) 3-15, a device I/F 3-20, a scanner image processing unit 3-80, and a printer image processing unit 3-90. These constituent elements are communicably connected to each other via the image bus I/F 3-05 and an image bus 3-08.

The CPU 3-01 boots an operating system (OS) through a boot program stored in the ROM 3-03. The CPU 3-01 executes various types of processing by executing on the OS a program stored in the storage 3-04.

The RAM 3-02 is used as a work area of the CPU 3-01. The RAM 3-02 also provides an image memory area for temporarily storing image data in addition to providing the work area.

The storage 3-04 stores programs and image data. As the storage 3-04, a hard disk drive (HDD), a solid-state drive (SSD), or an embedded multimedia card (eMMC) can be used. The storage 3-04 is also used as a user data storage area as a feature of the present exemplary embodiment.

The ROM 3-03, the RAM 3-02, the operation unit I/F 3-06, and a network I/F 3-10 are connected to the CPU 3-01 via the system bus 3-07. The USB host I/F 3-13 and the image bus I/F 3-05 are also connected to the CPU 3-01.

The operation unit I/F 3-06 is an interface for the operation unit 3-12. The operation unit I/F 3-06 outputs image data to be displayed on the operation unit 3-12 to the operation unit 3-12. The operation unit I/F 3-06 also transmits the information input by the user through the operation unit 3-12 to the CPU 3-01.

The network I/F 3-10 is an interface for connecting the image forming apparatus 1-01 to a local area network (LAN).

The USB host I/F 3-13 is an interface unit which communicates with the USB storage 3-14. The USB host I/F 3-13 also functions as an output unit for storing data stored in the storage 3-04, in the USB storage 3-14. Further, the USB host I/F 3-13 receives data stored in the USB storage 3-14 and transmits the data to the CPU 3-01.

The USB storage 3-14 is an external storage device for storing data, which can be attached to and detached from the USB host I/F 3-13. A plurality of USB devices including the USB storage 3-14 can be connected to the USB host I/F 3-13.

The RTC 3-15 controls the current time. The time information controlled by the RTC 3-15 is used for recording a job input time.

The image bus I/F 3-05 is a bus bridge for connecting the system bus 3-07 and the image bus 3-08 which forwards image data at high speed and for converting a data format.

The image bus 3-08 is configured by, for example, a peripheral component interconnect (PCI) bus. The device I/F 3-20, the scanner image processing unit 3-80, and the printer image processing unit 3-90 are provided to the image bus 3-08.

The scanner 3-70 and the printer 3-95 are connected to the device I/F 3-20. The device I/F 3-20 executes synchronous/asynchronous conversion of image data.

The scanner image processing unit 3-80 corrects, processes, and edits the image data input thereto.

The printer image processing unit 3-90 executes correction and resolution conversion of the output printing image data depending on the printer 3-95.

FIG. 3B is a block diagram illustrating a software configuration of the image forming apparatus 1-01 operating in the cloud browser system 1-00.

Each of the constituent elements expressed by a solid line in FIG. 3B is a software module implemented by the CPU 3-01 by executing a main program loaded on the RAM 3-02.

Execution of the below-described modules implemented by the main program is managed and controlled by the OS 3-51.

The UI control unit 3-52 displays a screen on the operation unit 3-12 and accepts operation performed by the user via the operation unit I/F 3-06. The UI control unit 3-52 also has a function of transmitting notifications to another module, receiving rendering instructions from the other module, and controlling update of the screen.

The job control unit 3-53 is a module which receives a job execution instruction from the UI control unit 3-52 to control the job processing, such as copying, scanning, and printing.

The NW control unit 3-54 receives a communication request from another module and controls communication with an external apparatus by controlling the network I/F 3-10. The NW control unit 3-54 also receives a notification from the external apparatus and notifies the contents of the notification to another module.

The storage control unit 3-55 stores and manages setting information, job information, and user data stored in the storage 3-04. Each of the modules existing in the layer of the OS 3-51 refers to a setting value and executes setting thereof by accessing the storage control unit 3-55.

The browser control unit 3-60 is one of the sub-modules included in the OS 3-51. The browser control unit 3-60 executes control unique to the cloud browser described below. The number of sub-modules included in the OS 3-51 is optional. As illustrated in FIG. 3B, the browser control unit 3-60 according to the present exemplary embodiment includes at least an image data acquisition unit 3-61, a browser operation unit 3-62, a browser display unit 3-63, a command I/F unit 3-64, and a user data processing unit 3-65.

Upon receiving a notification of a user operation from the UI control unit 3-52, the browser operation unit 3-62 notifies the contents of the user operation to the command I/F unit 3-64.

The command I/F unit 3-64 has a function of managing the entirety of the browser control unit 3-60. The command I/F unit 3-64 also receives a notification from the browser operation unit 3-62, and transmits a request to communicate with the image generation server 1-20 via the NW control unit 3-54. At this time, a notified information can be included in the communication request. The notified information includes information about user operations, such as a text input, a press of a link, scrolling, and zooming. The text includes, for example, a URL.

When a link is pressed, a coordinate of a pressed position in the operation unit 3-12 is included. When scrolling or zooming is executed, a corresponding character string is included. The command I/F unit 3-64 also receives a notification from the image generation server 1-20 via the NW control unit 3-54. The command I/F unit 3-64 processes the received contents and transmits a notification to the image data acquisition unit 3-61 or the browser display unit 3-63.

The image data acquisition unit 3-61 receives a rendering completion notification from the command I/F unit 3-64. When receiving the notification, the image data acquisition unit 3-61 transmits an image acquisition request to the image generation server 1-20. As illustrated in FIG. 2B, the image acquisition request is transmitted to the rendering control unit 2-53 operating on the virtual machine 1-07 included in the image generation server 1-20, and an image as a rendering result is transmitted from the rendering control unit 2-53 and returned to the image data acquisition unit 3-61. The image data acquisition unit 3-61 receives the rendering result and forwards the image as the rendering result to the browser display unit 3-63.

The browser display unit 3-63 receives the image from the image data acquisition unit 3-61 and instructs the UI control unit 3-52 to render the image. Alternatively, the browser display unit 3-63 receives a notification from the command I/F unit 3-64 and instructs the UI control unit 3-52 to display a message corresponding to the notification.

The user data processing unit 3-65 is a module which plays a central role of the present exemplary embodiment. The user data processing unit 3-65 cooperates with the storage control unit 3-55 to read and write the user data from/to a specific area of the storage 3-04. When the browser control unit 3-60 is activated, the user data processing unit 3-65 executes synchronization processing of user data stored in the cache of the image generation server 1-20 and user data stored in the storage of the image forming apparatus 1-01 or the like. The user data processing unit 3-65 executes user data back-up processing as appropriate in conjunction with the access to the Web page 1-05. Details thereof will be described below.

### <Flow of System Use>

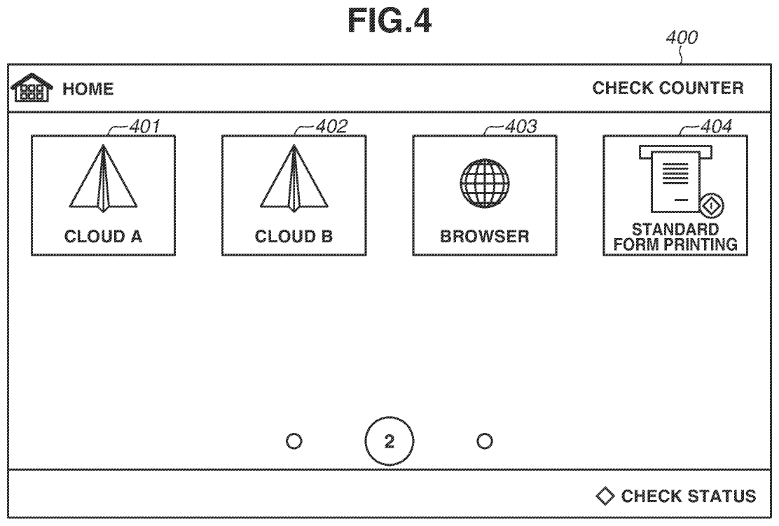

FIG. 4 is a diagram illustrating an example of a home screen displayed on the operation unit 3-12 of the image forming apparatus 1-01. A plurality of buttons which allows the user to input execution instructions of functions relating to the image forming apparatus 1-01 is displayed on a home screen 400. A button 401 corresponds to a function of a cloud A. A button 402 corresponds to a function of a cloud B. A button 403 corresponds to the cloud browser system 1-00. A button 404 corresponds to a “standard form printing” function.

When the user presses the button 403 of the browser, the browser control unit 3-60 illustrated in FIG. 3B is activated.

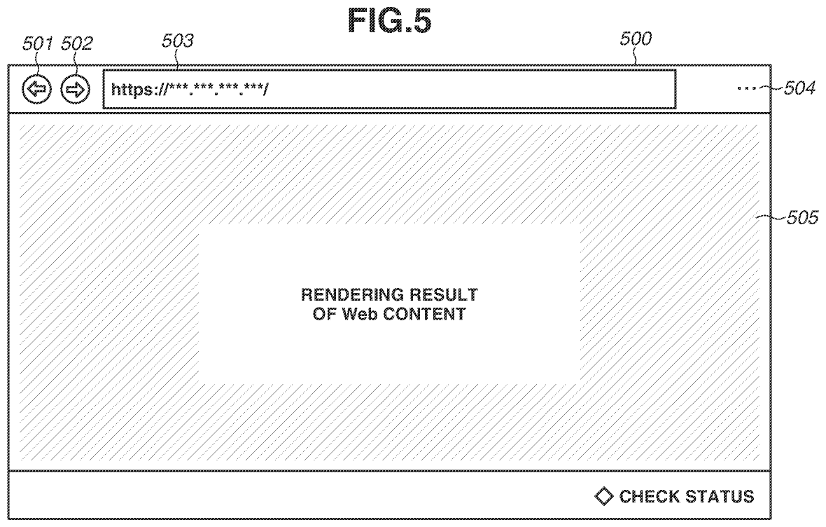

FIG. 5 is a diagram illustrating an example of the browser screen.

As described in FIG. 4, when the user presses the button 403 of the browser to cause the browser control unit 3-60 to be activated, a browser screen 500 illustrated in FIG. 5 is displayed on the operation unit 3-12 of the image forming apparatus 1-01 or the like.

The browser screen 500 includes a return button 501, an advance button 502, an address bar 503, and a setting button 504. On the lower side of these buttons, the browser screen 500 includes a content area 505 where a rendering result of the Web content is displayed. These constituent elements have functions similar to those included in the existing browser.

After the browser control unit 3-60 is activated, the browser does not display anything on the content area 505 until the URL is input thereto. Similarly to the existing browser, however, the browser can allow the user to register a default URL with an item described in the address bar 503 to display a rendering result of the Web content corresponding to the URL at the time of activation. In the example illustrated in FIG. 5, a rendering result of some sort of Web content acquired from a Web page indicated by the URL “https://***.***.***.***/” is displayed.

When the user operates the image forming apparatus 1-01 to input a browsing request of a desired Web page 1-05, a URL of the Web page 1-05 is transmitted to the image generation server 1-20 from the image forming apparatus 1-01 or the like via the Proxy 1-04. The overall control unit 2-51 receives and forwards the URL to the browser engine 2-52. In order to acquire Web content indicated by the URL, the browser engine 2-52 that has received the URL requests the NW control unit 2-54 to access the Web page 1-05 indicated by the URL. The NW control unit 2-54 that has received the access request controls the communication interface 2-05, and accesses the Web page 1-05 via the gateway 1-06 and the internet 1-11. The NW control unit 2-54 then acquires the Web content from the Web page 1-05 and forwards the Web content to the browser engine 2-52. Based on the forwarded Web content, the browser engine 2-52 analyzes the Web content by using the user data, such as a cookie cached in the RAM 2-03, as necessary.

The browser engine 2-52 also requests the rendering control unit 2-53 to execute rendering of the Web content based on the analysis. The rendering control unit 2-53 having received the request executes rendering of the Web content and notifies completion of rendering to the overall control unit 2-51.

The overall control unit 2-51 returns a rendering completion notification to the image forming apparatus 1-01 or the like as a request source of the URL via the NW control unit 2-54. The image forming apparatus 1-01 or the like having received the rendering completion notification transmits a rendering result acquisition request to the image generation server 1-20. This acquisition request is forwarded to the overall control unit 2-51 via the NW control unit 2-54, and the overall control unit 2-51 forwards the acquisition request to the rendering control unit 2-53. The rendering control unit 2-53 having received the rendering result acquisition request returns a rendering result to the image forming apparatus 1-01 or the like as a request source via the NW control unit 2-54.

The image forming apparatus 1-01 or the like displays the rendering result. Through the above-described processing, the user can browse the content of the desired Web page 1-05 by using the image forming apparatus 1-01. The image forming apparatus 1-01 can print or save the image of the browsed Web page 1-05.

### <User Data Management>

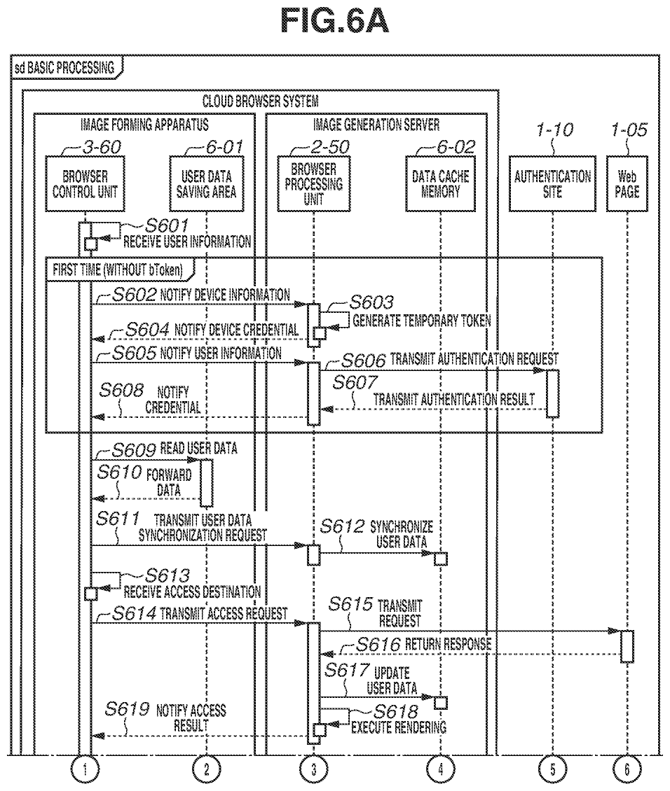

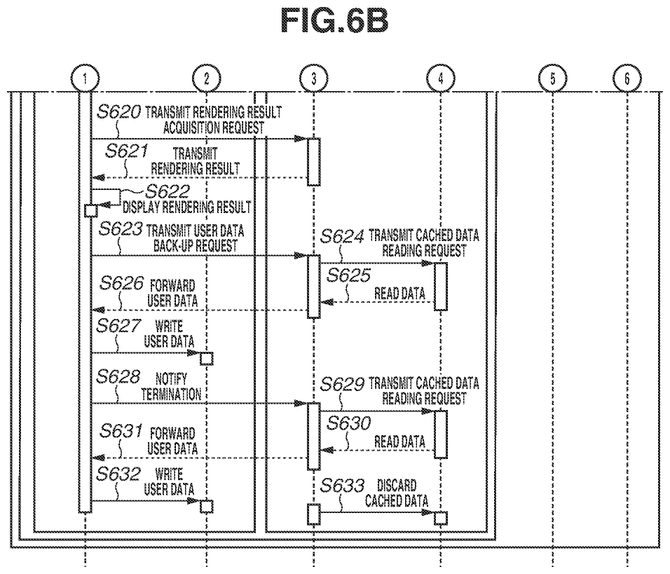

FIGS. 6A and 6B illustrate a sequence diagram of a standard exchanges executed by the respective blocks included in the cloud browser system 1-00.

The sequence diagram illustrates the exchanges executed among the browser control unit 3-60 as a software module of the image forming apparatus 1-01, the browser processing unit 2-50 as a software module of the image generation server 1-20, the authentication site 1-10, and the Web page 1-05.

The exchanges performed in steps S601 to S611 of the sequence diagram is executed when the browser control unit 3-60 connects to the image generation server 1-20 for the first time. From the second time, it is possible to display a rendering result of Web content of the Web page 1-05 on the operation unit 3-12 by executing only the processing in step S612 and subsequent steps without executing the processing in steps S601 to S611, until the below-described token is expired.

In step S601, the browser control unit 3-60 first requests the user to input user information through the browser operation unit 3-62 and the browser display unit 3-63. The user information is typically a user name and a password used for identifying an individual person at the authentication site 1-10.

The browser control unit 3-60 then determines whether the user information is input for the first time. If the user information is input for the first time, the processing in subsequent steps S602 to S608 is executed.

In step S602, the browser control unit 3-60 notifies, as device information, a unique identifier allocated to the image forming apparatus 1-01 to the browser processing unit 2-50. In the present exemplary embodiment, a media access control (MAC) address allocated to the image forming apparatus 1-01 is used as the identifier (identification information). However, unique information other than the MAC address can also be used. For example, a serial number of an apparatus allocated to the image forming apparatus 1-01 can also be used. Alternatively, a combination of the serial number and the MAC can more preferably be used as the information definitely unique thereto.

As described in FIG. 2B, the notified device information is forwarded to the overall control unit 2-51 serving as a sub-module of the browser control unit 2-50. In step S603, the overall control unit 2-51 generates a temporary token by using the identifier (identification information) as a key.

In subsequent steps S606 and S607, this temporary token is used for conducting the user authentication processing through the authentication site 1-10 by utilizing the ability of the browser processing unit 2-50.

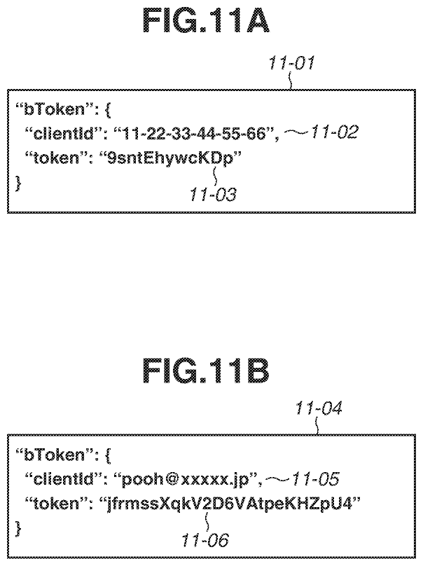

In step S604, a token (hereinafter, called “bToken”) is generated. The token includes the generated temporary token and the MAC address notified in step S602 as client information, which is unique to the cloud browser system 1-00. An example of the bToken is illustrated in FIG. 11A. The generated bToken is returned to the browser control unit 3-60 in a form of a device credential notification. FIG. 11A illustrates an example of the bToken notified to the browser control unit 3-60 from the browser processing unit 2-50 in step S604. A bToken 11-01 includes a clientId 11-02 and a token 11-03. The MAC address notified in step S601 is set to the clientId 11-02. The token generated in step S603 is set to the token 11-03.

In step S605, the user information input in step S601 and the bToken received in step S604 are notified to the browser processing unit 2-50 from the browser control unit 3-60 as the user information.

The notified user information is forwarded to the overall control unit 2-51 serving as a sub-module of the browser processing unit 2-50. The overall control unit 2-51 then instructs the browser engine 2-52 to conduct user authentication through the authentication site 1-10 based on the notified user information.

In step S606, the browser engine 2-52 transmits an authentication request to the authentication site 1-10. In the present exemplary embodiment, the user authentication is executed according to the OAuth 2.0 authentication framework defined by the Request for Comments (RFC) 6749. In order to easily implement the OAuth 2.0 authentication framework defined by the RFC 6749, ability of the browser engine 2-52 included in the browser processing unit 2-50 is particularly utilized. As described above, the temporary token is generated in step S603 in order to utilize the ability thereof. By generating the temporary token, user data, such as a cookie, used to execute user authentication can be prevented from being incorrectly recognized as user data of another image forming apparatus (e.g., image forming apparatus 1-02). However, the authentication method is not limited thereto. For example, the image generation server 1-20 can execute user management in a simplified manner. In this configuration, the ability of the browser processing unit 2-50 does not have to be utilized for executing user authentication, and it is not necessary to generate the temporary token. In other words, the processing in steps S602 to S604 is not necessary.

The authentication site 1-10 executes user authentication based on the forwarded user information, and returns a token of the authentication result in step S607.

Having received the token of the authentication result, the browser engine 2-52 of the browser processing unit 2-50 forwards that token to the overall control unit 2-51. In step S608, the overall control unit 2-51 generates a bToken which includes the received token and the user information received in step S601 as the client information. The overall control unit 2-51 of the browser processing unit 2-50 notifies the browser control unit 3-60 of the token as the user's credential. Further, in order to execute the authorization processing described below, the notified bToken is saved in the storage 1-09 together with the information about a validity period.

The browser control unit 3-60 having received the credential notification requests the storage control unit 3-55 to execute control, and saves the received bToken in the storage 3-04 included in the image forming apparatus 1-01. An example of the bToken is illustrated in FIG. 11B. FIG. 11B illustrates an example of the bToken notified to the browser control unit 3-60 from the browser processing unit 2-50 in step S608. Similarly to the bToken 11-01, a bToken 11-04 includes a clientId 11-05 and a token 11-06. A user name of the user information notified in step S606 is set to the clientId 11-05. The token received in step S608 is set to the token 11-06.

In a case where an input of the user information in step S601 is received for the second time or later, the processing in steps S602 to S608 can be skipped until the token issued by the authentication site 1-10 is expired. It is then possible to display a rendering result of the Web content of the Web page 1-05 on the operation unit 3-12 by executing only the processing in step S609 and subsequent steps.

The processing in subsequent steps S609 to S612 is processing specific to the present exemplary embodiment. In the present exemplary embodiment, user data stored in the storage 3-04 of the image forming apparatus 1-01 or the like and user data stored in the RAM 2-03 of the virtual machine 1-07 of the image generation server 1-20 are synchronized. More specifically, a user data saving area 6-01 independently managed based on the user information input in step S601 is allocated to the storage 3-04 of the image forming apparatus 1-01 or the like. If the browser engine 2-52 of the browser processing unit 2-50 is activated, a data cache memory 6-02 is automatically allocated to the RAM 2-03 of the virtual machine 1-07 of the image generation server 1-20. User data saved in the user data saving area 6-01 is then copied to the data cache memory 6-02. In a case where user data does not exist, an empty file is copied thereto. Details thereof will be described below.

The processing in step S613 and subsequent steps in the sequence diagram is a typical processing executed while the rendering result (rendering image) is displayed on the operation unit 3-12 of the image forming apparatus 1-01 or the like after the user inputs the URL of the Web page 1-05 as an access destination.

In step S613, the user inputs a URL of the Web page 1-05 as an access destination. Specifically, the user inputs the URL to the address bar 503 illustrated in FIG. 5. The above-described processing is executed through the browser operation unit 3-62 and the browser display unit 3-63. The present exemplary embodiment is described with respect to a case where the URL is directly input to the screen. However, similarly to the existing browser, a so-called bookmark list for managing a list of access destinations can also be retained therein, and the user is to allow to select an access destination from the list. Alternatively, in addition to the browser button 403 illustrated in FIG. 4, a button including an access destination can also be displayed on the screen, and the user is allowed to automatically specify the access destination by pressing the button.

In step S614, a request of access to the input URL is transmitted to the browser processing unit 2-50 from the browser control unit 3-60. At this time, in the present exemplary embodiment, the browser control unit 3-60 attaches the bToken notified in step S618 to that request to guarantee that the processing is a part of the processing flow. However, the bToken may not necessarily be attached if it is possible to guarantee that the processing is a part of the processing flow. For example, a tunnel which enables the browser control unit 3-60 and the browser processing unit 2-50 to execute point-to-point communication can be established before the processing in step S601 is executed, and communication executed within the tunnel can entirely be guaranteed.

The request of access transmitted in step S614 is distributed to the browser engine 2-52 from the overall control unit 2-51 as a sub-module of the browser processing unit 2-50. The browser engine 2-52 then acquires user data, such as a cookie, from the data cache memory 6-02 as necessary, although the processing is not illustrated. In steps S614 and S615, the above-described user data is user data acquired when Web browsing is executed before, for example.

In step S615, the browser engine 2-52 subsequently transmits an http request to the Web page 1-05 specified by the URL. At this time, the browser engine 2-52 uses the previously-acquired user data, such as the cookie, to execute communication.

In step S616, the Web page 1-05 having received the request returns the Web content to the browser engine 2-52 in a form of an http response.

In step S617, in a case where user data such as the cookie can be acquired through interpretation of the Web page 1-05, the data cache memory 6-02 is overwritten with the acquired user data.

In step S618, the browser engine 2-52 having received the Web content requests the rendering control unit 2-53 to execute rendering of the received Web content, and the rendering control unit 2-53 executes rendering processing.

If, in step S619, the rendering processing is completed, the rendering control unit 2-53 notifies the browser control unit 3-60 of an access result via the overall control unit 2-51.

In step S620, the browser control unit 3-60 having been notified of the access result transmits a rendering result acquisition request to the browser processing unit 2-50. In step S621, the overall control unit 2-51 of the browser processing unit 2-50 distributes the transmitted request to the rendering control unit 2-53, and the rendering result is returned to the browser control unit 3-60.

In step S622, the browser control unit 3-60 receives the rendering result returned thereto through the image data acquisition unit 3-61 and the browser display unit 3-63, and displays the rendering result on the operation unit 3-12.

Through the above-described processing, the Web content of the Web page 1-05 as a requested access destination are displayed on the operation unit 3-12 of the image forming apparatus 1-01 or the like. The processing in steps S614 to S622 is executed again even in a case where a link destination is selected.

Through the processing in subsequent steps S623 to S627, user data cached in the data cache memory 6-02 is backed up in the user data saving area 6-01. In the present exemplary embodiment, back-up processing is executed as appropriate in conjunction with the processing for accessing the Web page 1-05. In a case where user data does not exist, an empty file is backed up. Details thereof will be described below.

The processing in steps S628 to S633 described in the latter part of the sequence diagram corresponds to the user data back-up processing and the processing for discarding the contents of the data cash memory 6-02, executed when the browser control unit 3-60 closes the screen in FIG. 5 and ends the processing. The processing in steps S629 to S632 is exactly the same as the processing in steps S624 to S627 described above. However, in a case where a request transmitted by the browser control unit 3-60 is a termination notification in step S628, the browser processing unit 2-50 discards the contents of the data cache memory 6-02 in step S633. Through the above-described processing, user data is prevented from remaining in the cloud, and it is possible to obtain a secondary effect of the present exemplary embodiment, e.g., an effect of preventing occurrence of a security problem, such as leakage of user data.

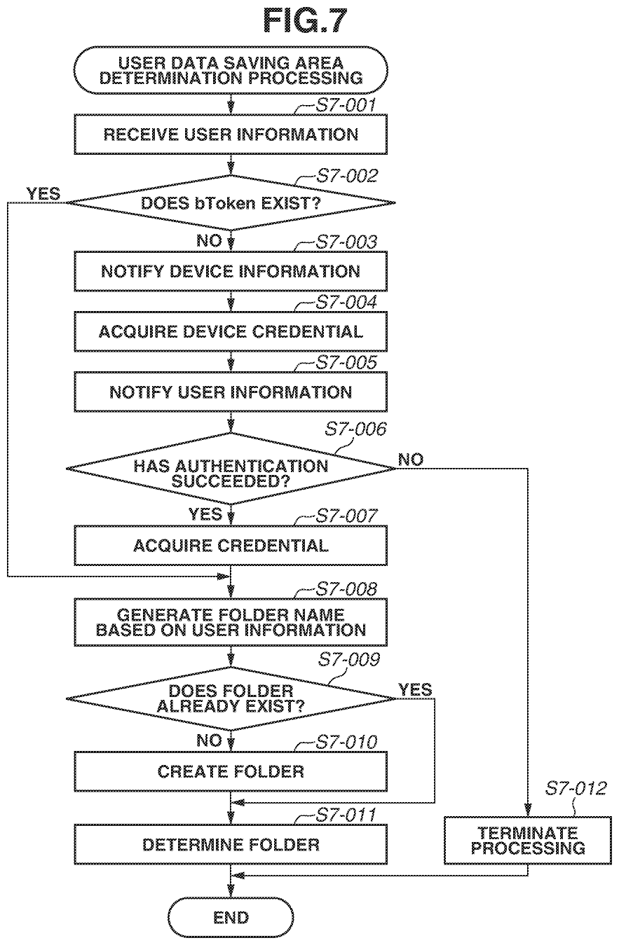

FIG. 7 is a flowchart illustrating a flow of user data saving area determination processing executed by the browser control unit 3-60.

The processing corresponding to the flowchart in FIG. 7 is executed by the CPU 3-01 in FIG. 3A as a part of the programs constituting the browser control unit 3-60 illustrated in FIG. 3B.

This processing illustrates the details of the processing executed in step S601 to immediately before step S609 in FIG. 6A. The processing is executed immediately after the browser control unit 3-60 illustrated in FIG. 3B is activated by a press of the browser button 403 in FIG. 4.

In step S7-001, the user is asked to input user information through the browser operation unit 3-62 and the browser display unit 3-63 as constituent elements of the browser control unit 3-60.

When the user inputs the user information, this information is forwarded to the command I/F unit 3-64 as a constituent element of the browser control unit 3-60, and the processing in steps S7-002 to S7-007 is executed by the command I/F unit 3-64.

In step S7-002, the browser control unit 3-60 determines whether use of the browser using the user information is a first time. As described above, if a bToken that includes a clientId conforming to the user information input in step S7-001 exists in the bTokens saved in the storage 3-04 in step S608 (YES in step S7-002), the browser control unit 3-60 determines that use of the browser is a second time or succeeding time, and the processing proceeds to step S7-008. If the browser control unit 3-60 determines that use of the browser is a first time (NO in step S7-002), the processing proceeds to step S7-003.

In step S7-003, the browser control unit 3-60 transmits the MAC address information to the image generation server 1-20, as described in step S602.

In step S7-004, as described in step S604, the browser control unit 3-60 receives a bToken unique to the cloud browser system 1-00, which includes the generated temporary token and the MAC address as the client information, as a device credential notification.

In step S7-005, the browser control unit 3-60 attaches the bToken received in step S7-004 to the user information received in step S7-001, and notifies the user information to the image generation server 1-20, as described in step S605.

The browser processing unit 2-50 of the image generation server 1-20 having received the user information requests the authentication site 1-10 to execute user authentication in step S606, receives a result in step S607, and notifies, in step S608, the browser control unit 3-60 of the image forming apparatus 1-01 or the like of the authentication result. In step S7-006, the browser control unit 3-60 determines whether the notified authentication result indicates that authentication has succeeded. If the authentication has succeeded (YES in step S7-006), the processing proceeds to step S7-007. If the authentication has failed (NO in step S7-006), the processing proceeds to step S7-012.

In step S7-007, the bToken transmitted as the credential information is received by the command I/F unit 3-64. The information is then transmitted to the user data processing unit 3-65 from the command I/F unit 3-64, and saved in the storage 3-04 via the storage control unit 3-55.

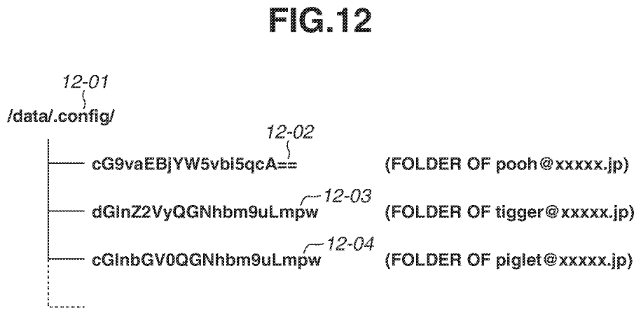

In step S7-008, the user data processing unit 3-65 generates a name of a folder for saving the user data in the storage 3-04, based on the user information (i.e., information about the clientId included in the bToken) received in step S7-001. FIG. 12 illustrates an example of the generated folder name. Details thereof will be described below.

In step S7-009, the browser control unit 3-60 determines whether a folder having the folder name generated in step S7-008 exists in the storage 3-04. If the folder exists (YES in step S7-009), the processing proceeds to step S7-011. If the folder does not exist (NO in step S7-009), the processing proceeds to step S7-010.

In step S7-010, a folder having the generated folder name is created in the storage 3-04.

In step S7-011, the browser control unit 3-60 determines the folder and ends the user data saving area determination processing. During the period when the Web page is being browsed, the user data is synchronized and backed up as appropriate by using the area within the determined folder.

In contrast, in a case where the authentication has failed in step S7-006, the processing proceeds to step S7-012. In step S7-012, the user data saving area determination processing is terminated. Information about the termination is notified to the browser display unit 3-63, and the browser display unit 3-63 displays a message describing that user authentication based on the input user information has failed. The browser control unit 3-60 according to the present exemplary embodiment ends the processing of the browser if the user has confirmed the message. The browser control unit 3-60 can also ask the user to input the user information again by bringing the processing back to step S7-001.

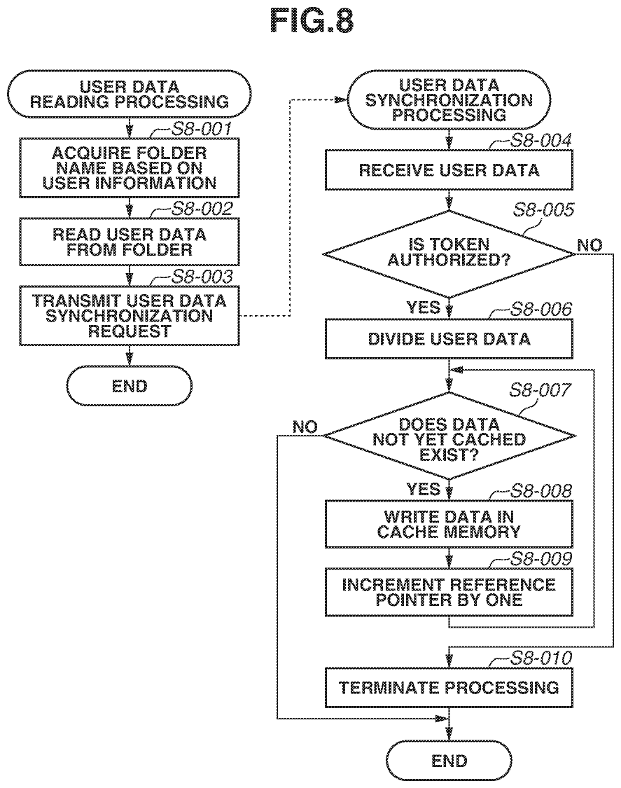

FIG. 8 is a flowchart illustrating a flow of user data synchronization processing executed by the browser control unit 3-60 and the browser processing unit 2-50.

The processing in steps S8-001 to S8-003 in FIG. 8 is executed by the CPU 3-01 in FIG. 3A as a part of the programs constituting the browser control unit 3-60 in FIG. 3B.

In contrast, the processing in steps S8-004 to S8-010 in FIG. 8 is executed by the CPU 2-01 in FIG. 2A as a part of the programs constituting the browser processing unit 2-50 in FIG. 2B.

The respective pieces of processing illustrated in FIG. 8 are executed in order to synchronize the user data. As described in the processing in steps S609 to S612 in FIG. 6A, the user data is stored in the storage 3-04 of the image forming apparatus 1-01 or the like and the RAM 2-03 of the virtual machine 1-07 of the image generation server 1-20. This synchronization processing is inevitably executed every time the browser control unit 3-60 is activated.

In step S8-001, the command I/F unit 3-64 as a constituent element of the browser control unit 3-60 in FIG. 3B drives the user data processing unit 3-65 to acquire a folder name based on the user information.

In step S8-002, the user data processing unit 3-65 reads out the user data backed up in the past from a folder having a folder name existing in the user data saving area 6-01 allocated to the storage 3-04, via the storage control unit 3-55. If this activation is for the first time, empty user data is read out.

In step S8-003, the command I/F unit 3-64 transmits a request of synchronization of the read user data to the image generation server 1-20. The read user data and the bToken acquired in step S608 in FIG. 6A are included in this request.

When the user data synchronization request is transmitted to the image generation server 1-20, contents of the user data synchronization request is provided to the overall control unit 2-51 serving as a constituent element of the browser processing unit 2-50, and the user data synchronization processing in FIG. 8 is started.

In step S8-004, the overall control unit 2-51 receives the user data and the bToken included in the user data synchronization request transmitted thereto.

In step S8-005, the overall control unit 2-51 authorizes the user data based on the bToken. In the present exemplary embodiment, as described in step S608 in FIG. 6A, the bToken notified in step S608 is saved in the storage 1-09 together with the validity period information. If a bToken having the unexpired validity period exists in the storage 1-09 (YES in step S8-005), the subsequent processing is authorized, and the processing proceeds to step S8-006. If such bToken does not exist or a validity period thereof is expired (NO in step S8-005), the processing proceeds to step S8-010. In the present exemplary embodiment, authorization is conducted based on a bToken stored in the storage 1-09 together with a validity period. However, the authorization can be conducted through a different method. For example, validity of a token can be checked with the authentication site 1-10 every time the authorization is necessary.

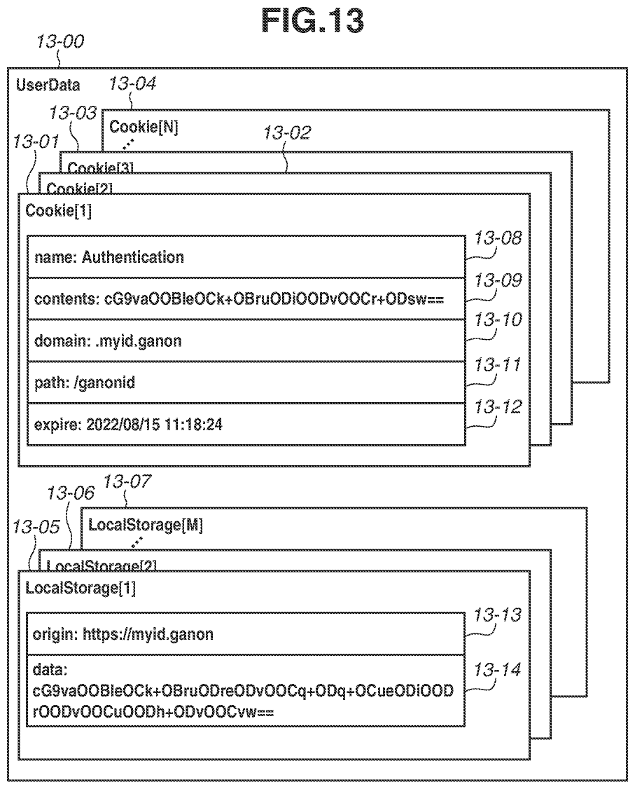

In step S8-006, the user data received in step S8-004 is divided. An example of the user data is illustrated in FIG. 13. A structure thereof is described below in detail. For example, the user data in FIG. 13 is divided into N pieces of cookies and M pieces of local storages. A piece of divided data is then individually written in the data cache memory 6-02.

Specifically, the browser processing unit 2-50 determines, in step S8-007, whether data not yet cached exists. If data exists (YES in step S8-007), the processing proceeds to step S8-008. If data does not exist (NO in step S8-007), the browser processing unit 2-50 ends the user data synchronization processing.

In step S8-008, the overall control unit 2-51 requests the browser engine 2-52 to execute user data registration by using an interface function provided by the browser engine 2-52. As described in FIGS. 6A and 6B, when the browser engine 2-52 of the browser processing unit 2-50 is activated, the data cache memory 6-02 is automatically allocated to the RAM 2-03 of the virtual machine 1-07 of the image generation server 1-20. The browser engine 2-52 having received the request of user data registration writes the user data in the data cache memory 6-02.

In step S8-009, a reference pointer is incremented by one. The processing then returns to step S8-007.

If the user data cannot be authorized in step S8-005, the user data synchronization processing is terminated in step S8-010. In such a case, information about the termination is notified to the browser control unit 3-60 from the browser processing unit 2-50. The information about the termination is transmitted to the browser display unit 3-63, and a message which describes failure in user data synchronization caused by, for example, expiration of a validity period of the input bToken is displayed thereon. At the same time, the bToken stored in the storage 3-04 is deleted, and the processing in steps S602 to S608 illustrated in FIG. 6A is executed again when the cloud browser system 1-00 is used next time.

Through the above-described processing, the user data stored in the storage 3-04 of the image forming apparatus 1-01 and the user data stored in the RAM 2-03 of the virtual machine 1-07 of the image generation server 1-20 are synchronized.

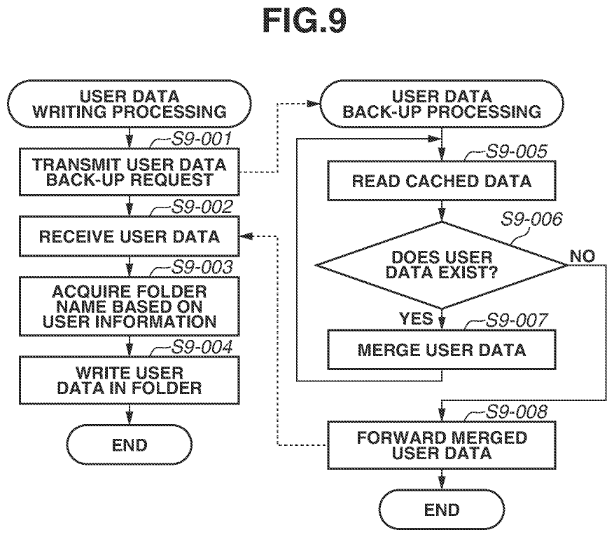

FIG. 9 illustrates the processing for backing up the user data in the storage 3-04 of the image forming apparatus 1-01 or the like. As described in the processing in steps S623 to S627 in FIG. 6B, this user data is stored in the RAM 2-03 of the virtual machine 1-07 of the image generation server 1-20. In the present exemplary embodiment, this back-up processing is executed as appropriate in conjunction with the processing for accessing the Web page 1-05. In addition, the back-up processing does not always have to be execute in conjunction with the processing for accessing the Web page 1-05. The browser engine 2-52 may transmit a status to the browser control unit 3-60 only when the user data is updated as described in step S617, and the browser control unit 3-60 executes the back-up processing only when the status is transmitted thereto. In this way, it is possible to reduce the communication frequency.

In step S9-001, the command I/F unit 3-64 as a constituent element of the browser control unit 3-60 in FIG. 3B transmits a user data back-up request to the image generation server 1-20.

In step S9-002, the command I/F unit 6-64 waits until user data to be backed up is returned from the image generation server 1-20.

When the user data back-up request is transmitted to the image generation server 1-20, the backup request is provided to the overall control unit 2-51 as a constituent element of the browser processing unit 2-50, and the user data back-up processing in FIG. 9 is started.

In step S9-005, the overall control unit 2-51 reads one piece of user data from the data cache memory 6-02 by using the interface function provided by the browser engine 2-52.

In step S9-006, the browser processing unit 2-50 determines whether the user data has been read out. If the user data has been read out (YES in step S9-006), the processing proceeds to step S9-007. If the user data cannot be read out (NO in step S9-006), the processing proceeds to step S9-008.

In step S9-007, the one piece of user data read out therefrom is merged with a trailing end of the merged user data, which is empty for the first time. The processing then returns to step S9-005.

In step S9-008, the merged user data is returned to the image forming apparatus 1-01 or the like.

In step S9-002, the merged user data returned to the image forming apparatus 1-01 or the like is forwarded to and received by the command I/F unit 3-64 serving as a constituent element of the browser control unit 3-60.

In step S9-003, the command I/F unit 3-64 drives the user data processing unit 3-65 to acquire a folder name based on the user information.

In step S9-004, the user data received in step S9-002 is written into a folder having the folder name acquired in step S9-003.

Through the above-described processing, the user data stored in the RAM 2-03 of the virtual machine 1-07 of the image generation server 1-20 is backed up in the storage 3-04 of the image forming apparatus 1-01 or the like.

In addition, in FIG. 9, the authorization processing of the token executed in step S8-005 in FIG. 8 is omitted. However, a security level thereof can be further improved by executing the similar authorization processing before the processing in step S9-005 is executed.

FIG. 12 illustrates an example of a structure of a folder where the user data is saved.

In the present exemplary embodiment, individual folders, i.e., child folders 12-02 to 12-04, are arranged under a parent folder 12-01. With this structure, private information can individually be managed by an independent path. A partition of the storage 3-04 is mounted so that the parent folder 12-01 is viewed as a path of “/data” from the browser control unit 3-60.

Folder names of the child folders 12-02 to 12-04 are examples of the folder name generated in step S7-008 illustrated in FIG. 7. A character string generated by encoding a user name of the user information through a conversion method “Base64” is used as a folder name of each of the child folders 12-02 to 12-04. FIG. 12 illustrates the child folders 12-02 to 12-04 having the folder names generated from the user information of “pooh”, “tigger”, and “piglet”.

In the present exemplary embodiment, a character string used as a child folder name is acquired through the Base64 method by executing encoding. However, the character string can be acquired through a method different from the Base64.

FIG. 13 is a diagram illustrating an example of a user data structure.

UserData 13-00 is the merged user data returned in step S9-008 in FIG. 9.

The UserData 13-00 in FIG. 13 is one example of the user data information. The UserData 13-00 includes N pieces of cookies, i.e., Cookie[1] 13-01 to Cookie[N] 13-04, and M pieces of local storages, i.e., LocalStorage[1] 13-05 to LocalStorage[M] 13-07.

One cookie includes constituent elements, such as a name 13-08, a contents 13-09, a domain 13-10, a path 13-11, and an expire 13-12.

In contrast, one local storage includes constituent elements, such as an origin 13-13, and a data 13-14.

One piece of user data is written in a cache in step S8-008 illustrated in FIG. 8, and read out from the cache in step S9-005 illustrated in FIG. 9. The one piece of user data is any one of the Cookie[i] (1≤i≤N) and the LocalStorage[j] (1≤j≤M) illustrated in FIG. 13.

According to the present exemplary embodiment as described above, a user data file of the user is normally retained in the apparatus, and cached in the cloud when used. In other words, user data files of a plurality of users can be managed in a distinguishable manner. Thus, a user who uses the cloud browser system 1-00 can execute Web browsing optimized for the user. For example, when the user uses the cloud browser system 1-00 to access an external cloud service which requires log-in operation, authentication information, such as an ID and a password, appropriate for the user in using can be input automatically. Further, private information, such as an address, an age, a gender, a phone number, and an e-mail address, of a user in using can be input automatically when the user uses the cloud browser system 1-00 to access a shopping site.

When the user uses a service, a user data file is cached in a cloud, and therefore the user does not have to transmit the user data file every time communication is executed. It is thereby possible to suppress degradation in response time of communication. Furthermore, the user data file cached in the cloud is deleted when use of the service is ended. It is thus possible to suppress occurrence of a security-related risk, such as leakage of user information cached in the cloud to the outside.

The present disclosure is not limited to the above-described exemplary embodiments. Various modifications and changes (which include an organic combination of the exemplary embodiments) can be made based on the essential spirit of the present disclosure, and such modifications and changes should not be excluded from the scope of the present disclosure.

The present disclosure can be realized by processing in which a program for realizing one or more functions according to the above-described exemplary embodiments is supplied to a system or an apparatus via a network or a storage medium, so that one or more processors in the system or the apparatus read and execute the program. Further, the present disclosure can also be realized with a circuit (e.g., application specific integrated circuit (ASIC)) that executes one or more functions.

The present disclosure is applicable to a system configured of a plurality of devices, or an apparatus configured of a single device. For example, a part of the software modules can be executed by an external server, and functions thereof can be implemented by acquiring a result processed by the external server.

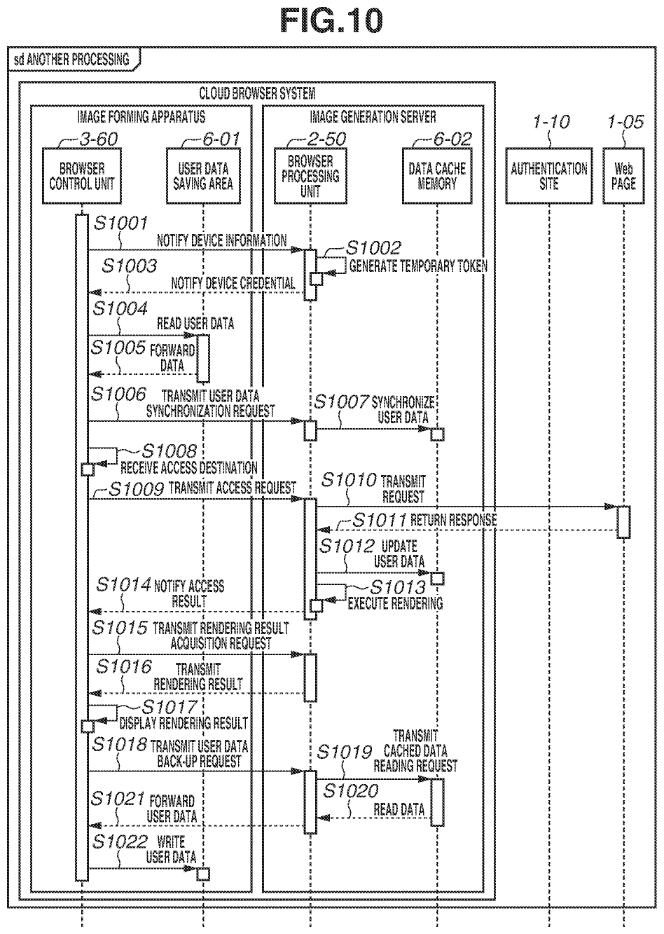

In the above-described exemplary embodiment, the image forming apparatus retains and manages a user data file for each user who uses the cloud browser system. However, in a case where one image forming apparatus is used by one user or only a limited number of users, a similar effect can be obtained by retaining and managing the user data for each apparatus instead of each user. An example of this processing is illustrated in FIG. 10. The processing in step S601 is not necessary because user data does not have to be managed for each user. The processing in steps S1001 to S1003 in FIG. 10 can be exactly the same as the processing in steps S602 to S604 in FIG. 6A. Even if execution of the processing is not limited to the first time as described in steps S602 to S604, it is not disadvantageous to the user because the processing in steps S1001 to S1003 can be executed without involvement of the user. The user data synchronization processing in step S1004 to S1007 is mostly the same as the processing in steps S609 to S612 in FIG. 6A, except for the processing executed in step S609, i.e., the processing in step S7-008 in FIG. 7 and the processing in step S8-001 in FIG. 8.

In the above-described exemplary embodiment, this processing step is necessary because a folder needs to be separated for each user.

However, a predetermined folder can be used because the user data is merely retained and managed for each apparatus. In a case where the folder is previously provided on the image forming apparatus before the browser control unit 3-60 is activated, processing corresponding to the processing in steps S7-009 and S7-010 in FIG. 7 does not have to be executed. The processing in steps S1008 to S1017 in FIG. 10 can also be exactly the same as the processing in steps S613 to S622 in FIGS. 6A and 6B. In contrast, the user data back-up processing in steps S1018 to S1022 in FIG. 10 is mostly the same as the processing in steps S623 to S627 in FIG. 6B. However, similar to the case of user data synchronization processing, the processing is different in that a folder name does not have to be acquired from the user information as described in step S9-003 in FIG. 9. Through such a configuration, user data can be retained and managed for each apparatus instead of each user.

Further, in the above-described exemplary embodiment, in step S601 of FIG. 6A, the user is asked to input user information every time. However, for example, the browser control unit 3-60 can request the storage control unit 3-55 to retain the received user information in the storage 3-04. In this way, the user data that has input once can be selected from a list from the next time, so that convenience thereof can be improved.

In the above-described exemplary embodiment, as described in the processing in steps S8-007 to S8-009 in FIG. 8, the overall control unit 2-51 individually writes pieces of user data in the cache by using the interface function provided by the browser engine 2-52. Similarly, in steps S9-005 to S-007 in FIG. 9, the overall control unit 2-51 individually reads out pieces of user data from the cache by using the interface function provided by the browser engine 2-52. However, the present disclosure can be realized without reading or writing pieces of user data individually. Specifically, the data cache memory 6-20 is provided such that the storage 1-09 of the image generation server 1-20 can be viewed to be equivalent to a network file system. By using the interface function provided by the browser engine 2-52, a persistent user data saving area is registered, and the area is used in place of the data cache memory 6-02. In the user data synchronization processing in FIG. 8, user data received from the browser control unit 3-60 is directly written into this persistent user data saving area. In the user data back-up processing in FIG. 8, user data read from the persistent user data saving area is directly forwarded to the browser control unit 3-60.

The effect of the present disclosure can also be obtained through the above-described configuration. In addition, from the viewpoint of security, cached data should certainly be discarded through the processing in step S633 of FIG. 6B in a case where the above-described method is to be employed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-141123, filed Sep. 6, 2022, which is hereby incorporated by reference herein in its entirety.

What is claimed is:

1. A Web browsing system comprising a server configured to perform rendering of a Web page and a communication terminal configured to display the Web page based on a result of the rendering,
wherein the communication terminal comprises:
a storage unit configured to store user data previously acquired from the server, the user data having been acquired through interpretation of the Web page;
a transmission unit configured to transmit address information of the Web page and the user data stored; and
a unit configured to receive a rendering image from the server, the rendering image corresponding to a result from accessing the Web page by using the user data,
wherein the server comprises:
a unit configured to receive the address information and the user data from the communication terminal; and
a unit configured to access the Web page based on the address information and the user data, generate the rendering image by interpreting the Web page, and transmit the rendering image to the communication terminal.

2. The Web browsing system according to claim 1, wherein the user data is managed in association with identification information.

3. The Web browsing system according to claim 2, wherein the identification information is information for identifying a user.

4. The Web browsing system according to claim 2, further comprising a unit configured to execute authentication processing based on the identification information.

5. The Web browsing system according to claim 2, further comprising a unit configured to request an external site to execute authentication processing based on the identification information.

6. The Web browsing system according to claim 2, further comprising a unit configured to acquire a token corresponding to the identification information.

7. The Web browsing system according to claim 2, further comprising a unit configured to create a folder based on the identification information,
wherein user data corresponding to the folder is stored in the folder.

8. The Web browsing system according to claim 1, further comprising a unit configured to create a folder based on the user data,
wherein user data corresponding to the folder is stored in the folder.

9. The Web browsing system according to claim 1, wherein the communication terminal is an image forming apparatus configured to form an image on a sheet.

10. The Web browsing system according to claim 1, wherein, when the communication terminal receives additional user data from the server, the communication terminal updates the user data stored with the additional user data.

11. A communication terminal capable of communicating with a server for rendering a Web page and configured to display the Web page based on a result of the rendering, the communication terminal comprising:
a unit configured to store user data previously acquired from the server, the user data having been acquired through interpretation of the Web page;
a unit configured to transmit address information of the Web page and the user data stored; and
a unit configured to receive a rendering image from the server, the rendering image corresponding to a result acquired by accessing the Web page by using the user data.

12. A control method of a communication apparatus capable of communicating with a server for rendering a Web page, the communication terminal displaying the Web page based on a result of the rendering, the control method comprising:
storing user data previously acquired from the server, the user data having been acquired through interpretation of the Web page;
transmitting address information of the Web page and the user data stored; and
receiving a rendering image from the server, the rendering image corresponding to a result acquired by accessing the Web page by using the user data.
